(19) United States
(12) Patent Application Publication
(10) Pub. No.: US 2013/0265328 A1
(43) Pub. Date: Oct. 10, 2013

(54) METHODS AND SYSTEMS FOR PROVIDING VIDEO OVERLAY FOR DISPLAY COUPLED TO INTEGRATED CHASSIS HOUSING A PLURALITY OF MODULAR INFORMATION HANDLING SYSTEMS

(71) Applicants: Timothy M. Lambert, Austin, TX (US); Babu Chandrasekhar, Round Rock, TX (US)

(72) Inventors: Timothy M. Lambert, Austin, TX (US); Babu Chandrasekhar, Round Rock, TX (US)

(73) Assignee: DELL PRODUCTS L.P., Round Rock, TX (US)

(21) Appl. No.: 13/443,125

(22) Filed: Apr. 10, 2012

(51) Int. Cl. G09G 5/36; G09G 5/00

(52) U.S. Cl. 345/629

(57) ABSTRACT

A modular information handling system may include an overlay agent and a baseboard management controller. The overlay agent may be embodied in a computer-readable medium and may comprise one or more executable instructions when read and executed by a processor for causing the processor to monitor for user input indicative of a user desire to invoke an overlay and communicate an indication that the user input indicative of the user desire to invoke the overlay has been received in response to receiving such user input. The baseboard management controller may be communicatively coupled to the processor and a memory and may be configured to read a video frame buffer from the memory, read an overlay region from the memory, and generate video output superimposing the video output represented by the overlay region over the video output represented by the video frame buffer in response to receiving the indication.

### TECHNICAL FIELD

The present disclosure relates in general to information handling systems, and more particularly to providing video overall for a display coupled to an integrated chassis housing a plurality of modular information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Existing server architectures either provide a single monolithic server capable of running one operating system and input/output (I/O) resources at a time, or bulky blade server chassis providing multiple servers and I/O control modules in a single chassis. A system chassis with multiple information handling systems with various peripheral and input/output capabilities common to the chassis as a whole may provide advantages, as it allows a blade server chassis in a small form factor, thereby providing a blade server chassis with a size comparable to the size of a monolithic server.

In a chassis having multiple modular information handling systems, it may be useful to provide a video overlay that may display over an information handling system's standard output settings and statuses associated with the various information handling systems and/or information handling resources housed therein (e.g., present focus of keyboard-video-mouse interface, associations of various information handling resources to information handling systems, etc.).

### SUMMARY

In accordance with the teachings of the present disclosure, the disadvantages and problems associated with providing video overlay information for an integrated chassis housing a plurality of modular information handling systems.

In accordance with certain embodiments of the present disclosure, a system may include a chassis configured to receive a plurality of modular information handling systems and at least one information handling system housed in the chassis. The at least one information handling system may include a processor, a memory, an overlay agent, and a baseboard management controller. The memory may be configured to store a video frame buffer representing video output to be displayed to a display communicatively coupled to the information handling system and an overlay region representing video output to be superimposed over the video output displayed to the display and represented by the video frame buffer when an overlay is invoked. The overlay agent may be embodied in a computer-readable medium and may comprise one or more executable instructions when read and executed by the processor for causing the processor to monitor for user input indicative of a user desire to invoke the overlay and communicate an indication that the user input indicative of the user desire to invoke the overlay has been received in response to receiving such user input. The baseboard management controller may be communicatively coupled to the processor and the memory and may be configured to read the video frame buffer, read the overlay region, and generate video output superimposing the video output represented by the overlay region over the video output represented by the video frame buffer in response to receiving from the processor the indication.

In accordance with other embodiments of the present disclosure, a modular information handling system may include a processor, a memory, an overlay agent, and a baseboard management controller. The memory may be configured to store a video frame buffer representing video output to be displayed to a display communicatively coupled to the information handling system and an overlay region representing video output to be superimposed over the video output displayed to the display and represented by the video frame buffer when an overlay is invoked. The overlay agent may be embodied in a computer-readable medium and may comprise one or more executable instructions when read and executed by the processor for causing the processor to monitor for user input indicative of a user desire to invoke the overlay and communicate an indication that the user input indicative of the user desire to invoke the overlay has been received in response to receiving such user input. The baseboard management controller may be communicatively coupled to the processor and the memory and may be configured to read the video frame buffer, read the overlay region, and generate video output superimposing the video output represented by the overlay region over the video output represented by the video frame buffer in response to receiving from the processor the indication.

Technical advantages of the present disclosure will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system chassis with multiple information handling systems and with various peripheral and input/output capabilities common to the chassis as a whole, in accordance with certain embodiments of the present disclosure; and

FIG. 2 illustrates a block diagram of selected components of the system depicted in FIG. 1, in accordance with certain embodiments of the present disclosure.

### DETAILED DESCRIPTION

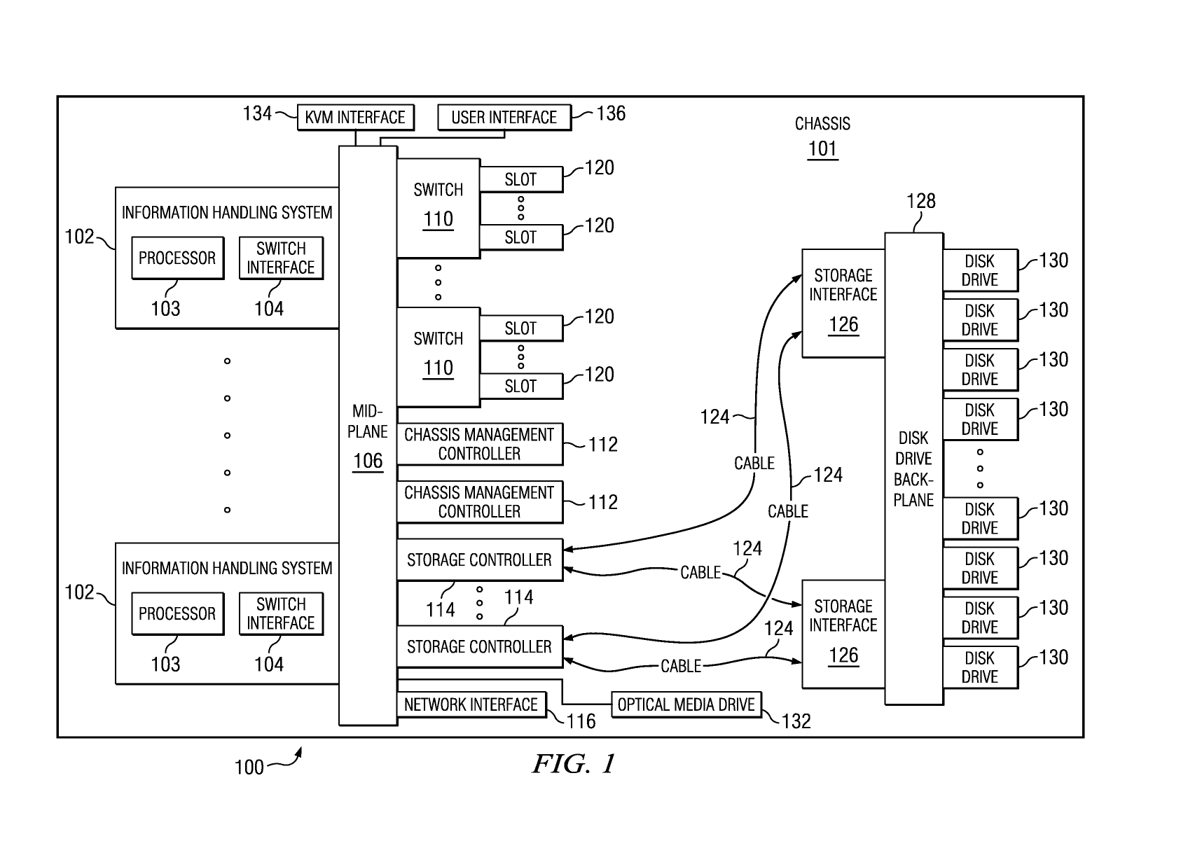

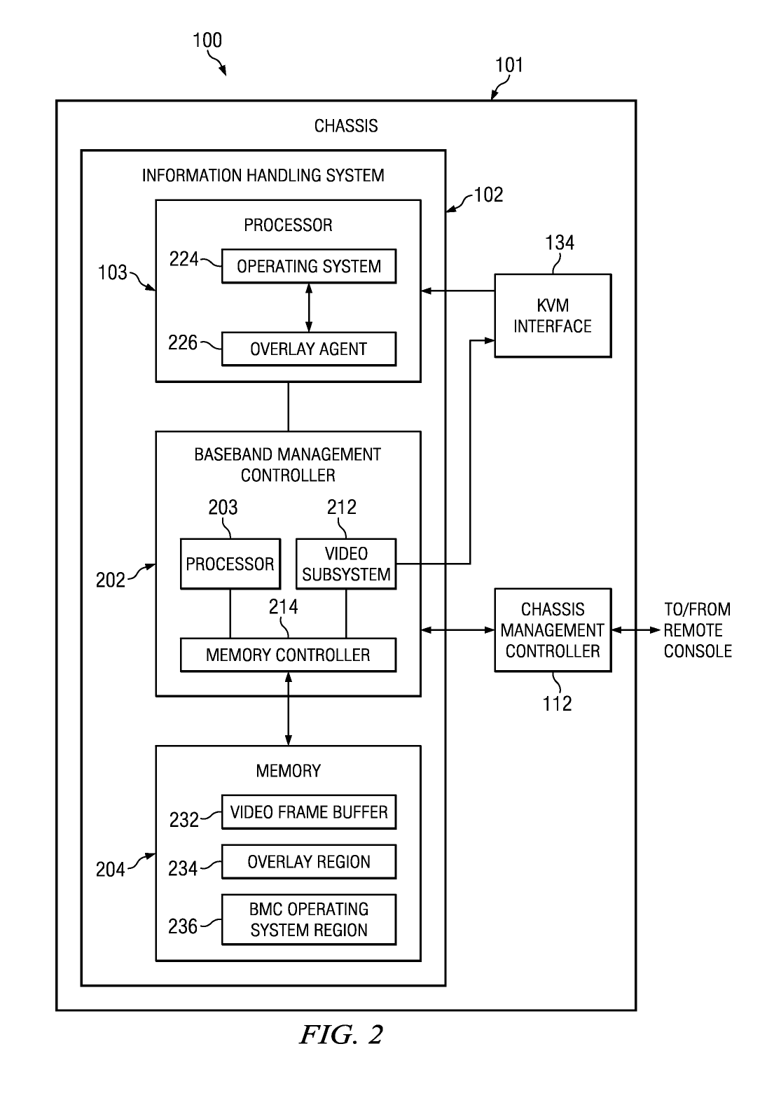

Preferred embodiments and their advantages are best understood by reference to FIGS. 1-2, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, information handling resources may broadly refer to any component system, device or apparatus of an information handling system, including without limitation processors, busses, memories, input-output devices and/or interfaces, storage resources, network interfaces, motherboards, electro-mechanical devices (e.g., fans), displays, and power supplies.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, microwaves, radio waves, and other electromagnetic and/or optical carriers; and/or any combination of the foregoing.

Information handling systems often use an array of physical storage resources (e.g., disk drives), such as a Redundant Array of Independent Disks (RAID), for example, for storing information. Arrays of physical storage resources typically utilize multiple disks to perform input and output operations and can be structured to provide redundancy which may increase fault tolerance. Other advantages of arrays of physical storage resources may be increased data integrity, throughput and/or capacity. In operation, one or more physical storage resources disposed in an array of physical storage resources may appear to an operating system as a single logical storage unit or “logical unit.” Implementations of physical storage resource arrays can range from a few physical storage resources disposed in a chassis, to hundreds of physical storage resources disposed in one or more separate storage enclosures.

FIG. 1 illustrates a block diagram of an example system 100 having a chassis 101 with multiple information handling systems 102 and with various peripheral and input/output capabilities common to chassis 101 as a whole, in accordance with certain embodiments of the present disclosure. As depicted in FIG. 1, system 100 may comprise a chassis 101 including a plurality of information handling systems 102, a mid-plane 106, one or more switches 110, one or more chassis management controllers 112, a network interface 116, one or more slots 120, one or more cables 124, one or more storage interfaces 126, a disk drive backplane 128, a plurality of disk drives 130, an optical media drive 132, a keyboard-video-mouse (KVM) interface 134, and a user interface 136.

An information handling system 102 may generally be operable to receive data from and/or communicate data to one or more disk drives 130 and/or other information handling resources of chassis 101 via mid-plane 106. In certain embodiments, an information handling system 102 may be a server. In such embodiments, an information handling system may comprise a blade server having modular physical design. In these and other embodiments, an information handling system 102 may comprise an M class server. As depicted in FIG. 1, an information handling system 102 may include a processor 103 and one or more switch interfaces 104 communicatively coupled to the processor 103.

A processor 103 may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in a memory, a hard drive 130, and/or another component of system 100.

A switch interface 104 may comprise any system, device, or apparatus configured to provide an interface between its associated information handling system 102 and switches 110. In some embodiments, switches 110 may comprise Peripheral Component Interconnect Express (PCIe) switches, in which case a switch interface 104 may comprise a mezzanine card configured to create a PCIe-compliant interface between its associated information handling system 102 and switches 110. In other embodiments, a switch interface 104 may comprise an interposer. Use of switch interfaces 104 in information handling systems 102 may allow for minimal changes to be made to traditional servers (e.g., M class servers) while supporting the overall system architecture disclosed herein. Although FIG. 1 depicts an implementation including a single switch interface 104 per information handling system 102, in some embodiments each information handling system 102 may include a plurality of switch interfaces 102 for redundancy, high availability, and/or other reasons.

Mid-plane 106 may comprise any system, device, or apparatus configured to interconnect modular information handling systems 102 with information handling resources of chassis 101. Accordingly, mid-plane 106 may include slots and/or connectors configured to receive information handling systems 102, switches 110, chassis management controllers 112, storage controllers 114, network interface 116, optical media drive 132, KVM interface 134, user interface 136, and/or other information handling resources. In one embodiment, mid-plane 106 may include a single board configured to interconnect modular information handling systems 102 with information handling resources. In another embodiment, mid-plane 106 may include multiple boards configured to interconnect modular information handling systems 102 with information handling resources. In yet another embodiment, mid-plane 106 may include cabling configured to interconnect modular information handling systems 102 with information handling resources.

A switch 110 may comprise any system, device, or apparatus configured to couple information handling systems 102 to storage controllers 114 (e.g., via mid-plane 106) and slots 120 and perform switching between information handling systems 102 and various information handling resources of system 100, including storage controllers 114 and slots 120. In certain embodiments, a switch 110 may comprise a PCIe switch. In other embodiments, a switch may comprise a generalized PC bus switch, an Infiniband switch, or other suitable switch. As shown in FIG. 1, chassis 101 may include a plurality of switches 110. In such embodiments, switches 110 may operate in a redundant mode for shared devices (e.g., storage controllers 114 and/or devices coupled to slots 120) and in non-redundant mode for non-shared/zoned devices. As used herein, shared devices may refer to those which may be visible to more than one information handling system 102, while non-shared devices may refer to those which are visible to only a single information handling system 102.

A chassis management controller 112 may be any system, device, or apparatus configured to facilitate management and/or control of system 100, its information handling systems 102, and/or one or more of its component its component information handling resources. A chassis management controller 102 may be configured to issue commands and/or other signals to manage and/or control information handling system 102 and/or information handling resources of system 100. A chassis management controller 112 may comprise a microprocessor, microcontroller, digital signal processor (DSP), application specific integrated circuit (ASIC), field programmable gate array (FPGA), erasable programmable read-only memory (EPROM), or any combination thereof. As shown in FIG. 1, a chassis management controller 112 may be coupled to mid-plane 106. Also as shown in FIG. 1, system 100 may include a plurality of chassis management controllers 112, and in such embodiments, chassis management controllers 112 may be configured as redundant. In some embodiments, a chassis management controller 112 may provide a user interface and high level controls for management of switches 110, including configuring assignments of individual information handling systems 102 to non-shared information handling resources of system 100. In these and other embodiments, a chassis management controller may define configurations of the storage subsystem (e.g., storage controllers 114, storage interfaces 126, disk drives 130, etc.) of system 100. For example, a chassis management controller may provide physical function configuration and status information that would normally occur at the driver level in traditional server implementations. Examples of physical functions include disk drive discovery and status, RAID configuration and logical volume mapping.

In addition or alternatively, a chassis management controller 112 may also provide a management console for user/administrator access to these functions. For example, a chassis management controller 112 may implement Intelligent Platform Management Interface (IPMI) or another suitable management protocol permitting a user to remotely access a chassis management controller 112 to configure system 100 and its various information handling resources. In such embodiments, a chassis management controller 112 may interface with a network interface separate from network interface 116, thus allowing for “out-of-band” control of 100, such that communications to and from chassis management controller 112 are communicated via a management channel physically isolated from an “in band” communication channel with network interface 116. Thus, for example, if a failure occurs in system 100 that prevents an administrator from interfacing with system 100 via network interface 116 and/or user interface 136 (e.g., operating system failure, power failure, etc.), the administrator may still be able to monitor and/or manage system 100 (e.g., to diagnose problems that may have caused failure) via a chassis management controller 112. In the same or alternative embodiments, chassis management controller 112 may allow an administrator to remotely manage one or parameters associated with operation of system 100 and its various information handling resources (e.g., power usage, processor allocation, memory allocation, security privileges, etc.). Although FIG. 1 depicts chassis as having two chassis management controllers 112, chassis 101 may include any suitable number chassis management controllers 112.

A storage controller 114 may and include any system, apparatus, or device operable to manage the communication of data between one or more of information handling systems 102 and one or more of disk drives 130. In certain embodiments, a storage controller 114 may provide functionality including, without limitation, disk aggregation and redundancy (e.g., RAID), input/output (I/O) routing, and error detection and recovery. As shown in FIG. 1, a storage controller 114 may coupled to a connector on mid-plane 106. Also as shown in FIG. 1, system 100 may include a plurality of storage controllers 114, and in such embodiments, storage controllers 114 may be configured as redundant. In addition or in the alternative, storage controllers 114 may in some embodiments be shared among two or more information handling systems 102. As also shown in FIG. 1, each storage controller 114 may be coupled to one or more storage interfaces 126 via cables 124. For example, in some embodiments, each storage controller 114 may be coupled to a single associated storage interface 126 via a cable 124. In other embodiments, each storage controller 114 may be coupled to two or more storage interfaces 126 via a plurality of cables 124, thus permitting redundancy as shown in FIG. 1. Storage controllers 114 may also have features supporting shared storage and high availability. For example, in PCIe implementations, a unique PCIe identifier may be used to indicate shared storage capability and compatibility in system 100.

As depicted in FIG. 1, a switch 110 may have coupled thereto one or more slots 120. A slot 120 may include any system, device, or apparatus configured to allow addition of one or more expansion cards to chassis 101 in order to electrically coupled such expansion cards to a switch 110. Such slots 120 may comprise any suitable combination of full-height risers, full-height slots, and low-profile slots. A full-height riser may include any system, device, or apparatus configured to allow addition of one or more expansion cards (e.g., a full-height slot) having a physical profile or form factor with dimensions that practically prevent such expansion cards to be coupled in a particular manner (e.g., perpendicularly) to mid-plane 106 and/or switch 110 (e.g., the proximity of information handling resources in chassis 101 prevents physical placement of an expansion card in such manner). Accordingly, a full-height riser may itself physically couple with a low-profile to mid-plane 106, a switch 110, or another components, and full-height cards may then be coupled to full-height slots of full-height riser. On the other hand, low-profile slots may be configured to couple low-profile expansion cards to switches 110 without the need for a full-height riser.

Slots 120 may also include electrically conductive elements (e.g., edge connectors, traces, etc.) allowing for expansion cards inserted into slots 120 to be electrically coupled to switches 110. In operation, switches 110 may manage switching of communications between individual information handling systems 102 and expansion cards coupled to slots 120. In some embodiments, slots 120 may be nonshared (e.g., each slot 120 is associated with a single information handling system 102). In other embodiments, one or more of slots 120 may be shared among two or more information handling systems 102. In these and other embodiments, one or more slots 120 may be configured to be compatible with PCIe, generalized PC bus switch, Infiniband, or other suitable communication specification, standard, or protocol.

Network interface 116 may include any suitable system, apparatus, or device operable to serve as an interface between chassis 101 and an external network (e.g., a local area network or other network). Network interface 116 may enable information handling systems 102 to communicate with the external network using any suitable transmission protocol (e.g., TCP/IP) and/or standard (e.g., IEEE 802.11, Wi-Fi). In certain embodiments, network interface 116 may include a network interface card (NIC). In the same or alternative embodiments, network interface 116 may be configured to communicate via wireless transmissions. In the same or alternative embodiments, network interface 116 may provide physical access to a networking medium and/or provide a low-level addressing system (e.g., through the use of Media Access Control addresses). In some embodiments, network interface 116 may be implemented as a local area network (LAN) on motherboard (LOM) interface.

In some embodiments, various components of chassis 101 may be coupled to a planar. For example, a planar may interconnect switches 110, chassis management controller 112, storage controllers 114, network interface 116, optical media drive 132, KVM interface 134, user interface 136, and/or other modular information handling resources of chassis 101 to mid-plane 106 of system 100. Accordingly, such planar may include slots and/or connectors configured to interconnect with such information handling resources.

Storage interfaces 126 may include any system, device, or apparatus configured to facilitate communication between storage controllers 114 and disk drives 130. For example, a storage interface may serve to permit a relatively small number of communication links (e.g., two) between storage controllers 114 and storage interfaces 126 to communicate with a greater number of disk drives 130. Thus, a storage interface 126 may provide a switching mechanism and/or disk drive addressing mechanism that allows an information handling system 102 to communicate with numerous disk drives 130 via a limited number of communication links and/or channels. Accordingly, a storage interface 126 may operate like an Ethernet hub or network switch that allows multiple systems to be coupled using a single switch port (or relatively few switch ports). A storage interface 126 may be implemented as an expander (e.g., a Serial Attached SCSI (SAS) expander), an Ethernet switch, a FibreChannel switch, Internet Small Computer System Interface (iSCSI) switch, or any other suitable switch. In order to support high availability storage, system 100 may implement a plurality of redundant storage interfaces 126, as shown in FIG. 1.

Disk drive backplane 128 may comprise any system, device, or apparatus configured to interconnect modular storage interfaces 126 with modular disk drives 130. Accordingly, disk drive backplane 128 may include slots and/or connectors configured to receive storage interfaces 126 and/or disk drives 130. In some embodiments, system 100 may include two or more backplanes, in order to support differently-sized disk drive form factors. To support redundancy and high availability, a backplane 128 may be configured to receive a plurality (e.g., 2) of storage interfaces 126 which couple two storage controllers 114 to each disk drive 130.

Each disk drive 130 may include computer-readable media (e.g., magnetic storage media, optical storage media, opto-magnetic storage media, and/or other type of rotating storage media, flash memory, and/or other type of solid state storage media) and may be generally operable to store data and/or programs (e.g., one or more operating systems and/or one or more application programs). Although disk drives 130 are depicted as being internal to chassis 101 in FIG. 1, in some embodiments, one or more disk drives may be located external to chassis 101 (e.g., in one or more enclosures external to chassis 101).

Optical media drive 132 may be coupled to mid-plane 106 and may include any suitable system, apparatus, or device configured to read data from and/or write data to an optical storage medium (e.g., a compact disc (CD), digital versatile disc (DVD), blue laser medium, and/or other optical medium). In certain embodiments, optical media drive 132 may use laser light or other electromagnetic energy to read and/or write data to an optical storage medium. In some embodiments, optical media drive 132 may be nonshared and may be user-configurable such that optical media drive 132 is associated with a single information handling system 102.

KVM interface 134 may be coupled to mid-plane 106 and may include any suitable system, apparatus, or device configured to couple to one or more of a keyboard, video display, and mouse and act as switch between multiple information handling systems 102 and the keyboard, video display, and/or mouse, thus allowing a user to interface with a plurality of information handling systems 102 via a single keyboard, video display, and/or mouse.

User interface 136 may include any system, apparatus, or device via which a user may interact with system 100 and its various information handling resources by facilitating input from a user allowing the user to manipulate system 100 and output to a user allowing system 100 to indicate effects of the user's manipulation. For example, user interface 136 may include a display suitable for creating graphic images and/or alphanumeric characters recognizable to a user, and may include, for example, a liquid crystal display (LCD), cathode ray tube (CRT), a plasma screen, and/or a digital light processor (DLP) projection monitor. In certain embodiments, such a display may be an integral part of chassis 101 and receive power from power supplies (not explicitly shown) of chassis 101, rather than being coupled to chassis 101 via a cable. In some embodiments, such display may comprise a touch screen device capable of receiving user input, wherein a touch sensor may be mechanically coupled or overlaid upon the display and may comprise any system, apparatus, or device suitable for detecting the presence and/or location of a tactile touch, including, for example, a resistive sensor, capacitive sensor, surface acoustic wave sensor, projected capacitance sensor, infrared sensor, strain gauge sensor, optical imaging sensor, dispersive signal technology sensor, and/or acoustic pulse recognition sensor. In these and other embodiments, user interface 136 may include other user interface elements (e.g., a keypad, buttons, and/or switches placed in proximity to a display) allowing a user to provide input to system 100. User interface 136 may be coupled to chassis management controllers 112 and/or other components of system 100, and thus may allow a user to configure various information handling resources of system 100 (e.g., assign individual information handling systems 102 to particular information handling resources).

FIG. 2 illustrates a block diagram of selected components of the system depicted in FIG. 1, in accordance with certain embodiments of the present disclosure. In particular, FIG. 2 depicts an example architecture for providing video overlay for a display coupled chassis 101 (e.g., via KVM interface 134). It is noted that for the purposes of clarity, certain elements that may be present in chassis 101 are not shown in FIG. 2. For example, FIG. 2 depicts only a single information handling system 102, despite that it is contemplated that chassis 101 may be configured to house multiple information handling systems 102. In addition, the functionality and structure of an information handling system 102 as discussed with regard to FIG. 2 may be present in some or all of information handling systems 102 present in system 100. As another example, FIG. 2 depicts an information handling system 102 communicatively coupled to KVM interface 134 and chassis management controller 112 despite that it is contemplated that one or two other devices (e.g., switch interfaces 104, midplane 106, and/or others) may in some embodiments interface between an information handling system 102 and KVM interface 134 and/or chassis management controller 112.

As shown in FIG. 2, an information handling system 102 may comprise, in addition to or in lieu of those elements described in FIG. 1, a baseboard management controller 202 and a memory 204. A baseboard management controller 202 may be coupled to processor 103 and may include any system, device, or apparatus configured to allow system administrators to manage and associated information handling system 102 and/or monitor its operation of such information handling system 102. Baseboard management controller 202 include, for example, a microcontroller embedded on a motherboard of information handling system 202 configured to manage an interface between system management software executing on an information handling system 102 and other components of an information handling system 102. In certain embodiments, baseboard management controller 202 may be configured to provide an Intelligent Platform Management Interface (IPMI). As shown in FIG. 2, baseboard management controller 202 may include a processor 203, a video subsystem 212, and a memory controller 214.

A processor 203 may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 203 may be similar in functionality or structure to processor 103.

Video subsystem 212 may include any system, device, or apparatus configured to generate images for display to a display device, and may include without limitation a graphics card, graphics accelerator, and/or other information handling resources suitable for image generation and/or output.

Memory controller 214 may be communicatively coupled to processor 203 and video subsystem 212 and may comprise any system, device, or apparatus configured to manage and/or control memory 204. For example, memory controller 214 may be configured to read data from and/or write data to memory modules comprising memory 204. Additionally or alternatively, memory controller 214 may be configured to refresh memory modules in embodiments in which memory 204 comprises dynamic random access memory (DRAM).

Memory 204 may be communicatively coupled to processor 203 and video subsystem 212 and may comprise any system, device, or apparatus operable to retain program instructions or data for a period of time (e.g., computer-readable media). Memory 204 may comprise random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to an associated information handling system 102 is turned off. In particular embodiments, memory 204 may comprise dynamic random access memory (DRAM). As shown in FIG. 2, memory 204 may include a plurality of regions wherein each region is configured to store a specific type of data. For example, memory 204 may include video frame buffer 232, overlay region 234, and baseboard management controller operating system region 236. Video frame buffer 232 may comprise information representing color values for every pixel to be displayed to a display (e.g., a display coupled to KVM interface 134).

Overlay region 234 may comprise information representing color values for every pixel that may be displayed as an overlay that may be displayed on a display device over the image represented by video frame buffer 232. Such information may include parameters and settings associated with the various information handling systems 102 and information handling resources of system 100, including without limitation information regarding specific the information handling system 102 upon which the baseboard management controller 202 resides (e.g., a slot number, model number, serial number, status information, etc.), information regarding which information handling resources are associated with particular information handling systems 102 (e.g., which information handling system 102 is the present focus of KVM interface 134, to which information handling system 102 optical media drive 132 is assigned, to which information handling system 102 a particular input/output device is assigned, etc.).

Baseboard management controller operating system region 236 may include executable instructions to govern operation of baseboard management controller 202 which may be read and executed by processor 203.

As shown in FIG. 2, processor 103 may execute operating system 224 and overlay agent 226. Operating system 224 and/or overlay agent may be read from any suitable computer-readable medium (e.g., memory 204, disk drive 130, or another computer-readable medium accessible to processor 103). Operating system 224 may comprise one of more programs of instructions that manage an information handling system and information handling resources associated therewith and provide common services for application software. Overlay agent 226 may comprise one or more programs of instructions configured to execute on operating system 226 may be configured to monitor for user stimulus (e.g., from KVM interface 134) for invoking a video overlay, as described in greater detail below.

In operation, various stimuli may invoke a video overlay to be displayed to a display device associated with system 100 (e.g., a display coupled to KVM interface 134). Such stimuli may include, without limitation, detection of a change of focus of KVM interface 134 from one information handling system 102 to another (e.g., a Blade Select signal indication from a chassis management controller 112 or KVM interface 134), warnings or error events generated by a chassis management controller 112 or baseboard management controller 202, remote console instruction (e.g., to notify users of an information handling system 102 that the remote console or administrator may be taking server control or performing offline service actions), and/or by specific input received from KVM interface 134 (e.g., specific keystrokes or “hot keys”). In the case of specific input received from KVM interface 134, overlay agent 226 may monitor or “snoop” for particular keystrokes indicating a user desire to invoke a video overlay, and trap on such keystrokes. In response to trapping on such keystrokes, overlay agent 226 may then communicate with baseboard management controller 202 (e.g., via IPMI commands) until such time as another stimulus (e.g., additional particular keystrokes) is received indicating the overlay display is to be closed. While the video overlay is invoked, overlay agent 226 may intercept keystrokes and redirect them to baseboard management controller instead of to operating system 224.

Such intercepted keystrokes may allow a user to interact with the video overlay to configure and/or view status information related to system 100 and its various components. For example, information in a video overlay may include status information associated with an information handling system 202, including without limitation a physical slot location, unique identifier, health, inventory, power state, events logs, etc. As another example, information in a video overlay may include status of chassis 101 as a whole received by baseboard management controller 202 from a chassis management controller 112, including without limitation shared keyboard/video/mouse functionality, assignable or shared information handling resources (e.g., disk drives 130, optical media drive 132, etc.), and/or other information. In such a scenario, a chassis management controller may provide data for display in the video overlay and/or invoke the overlay for a particular information handling system 102 or broadcast such information to multiple information handling systems 102. As an additional example, information in video overlay may include messages from authorized remote consoles received via a chassis management controller 112 (e.g., that a remote administrator may soon shutdown one or more information handling systems 102 at a given time).

In addition, such intercepted keystrokes may allow a user to interact with the video overlay to configure a chassis management controller 112 and/or a baseboard management controller 202 by traversing menus, manipulating data fields, and/or other inputting data. Thus, the user may, with respect to a baseboard management controller 202, clear logs, configure security options, power an information handling system on or off, etc.). As another example, a user may modify assignments of shared elements within chassis 101 (e.g., assignment of focus of KVM interface 134 to a particular information handling system 102, assignment of disk drives 130 to particular information handling systems, etc.). In such a situation, a baseboard management controller 202 may passes user commands to a chassis management controller 112 to make such assignments.

In addition, a baseboard management controller 202 may, in response to receiving an indication to invoke a video overlay, invoke the video overlay by instructing video subsystem 212 to superimpose data in overlay region 234 over data in video frame buffer 232 and communicating such data to KVM interface 134 for display to a display device. Further, a chassis management controller 112 may communicate information to baseboard management controllers 202 to be stored as data in overlay region 234, may receive information from baseboard management controller 202 to modify settings, and/or may modify settings in response to such received information.

Although the present disclosure has been described in detail, it should be understood that various changes, substitutions, and alterations can be made hereto without departing from the spirit and the scope of the disclosure as defined by the appended claims.

What is claimed is:

1. A system comprising:
a chassis configured to receive a plurality of modular information handling systems;
at least one information handling system housed in the chassis, the at least one information handling system comprising:
a processor;
a memory, the memory configured to store:
a video frame buffer representing video output to be displayed to a display communicatively coupled to the information handling system; and
an overlay region representing video output to be superimposed over the video output displayed to the display and represented by the video frame buffer when an overlay is invoked;
an overlay agent embodied in a computer-readable medium and comprising one or more executable instructions when read and executed by the processor for causing the processor to:
monitor for user input indicative of a user desire to invoke the overlay; and
communicate an indication that the user input indicative of the user desire to invoke the overlay has been received in response to receiving such user input;
a baseboard management controller communicatively coupled to the processor and the memory, the baseboard management controller configured to:
read the video frame buffer;
read the overlay region; and
generate video output superimposing the video output represented by the overlay region over the video output represented by the video frame buffer in response to receiving from the processor the indication.

2. A system according to claim 1, further comprising a keyboard-video-mouse interface configured to receive the user input indicative of the user desire to invoke the overlay.

3. A system according to claim 1, further comprising a keyboard-video-mouse interface and the baseboard management controller further configured to communicate to the keyboard-video-mouse interface video output superimposing the video output represented by the overlay region over the video output represented by the video frame buffer.

4. A system according to claim 1, the overlay agent further configured to, while the overlay is invoked, forward user input to the baseboard management controller.

5. A system according to claim 4, the overlay agent further configured to, while the overlay is invoked, prevent an operating system executing the on processor from receiving user input forwarded to the baseboard management controller.

6. A system according to claim 4, the baseboard management controller further configured to, while the overlay in invoked:
modify content in the overlay region in response to user input forwarded to the baseboard management controller; and
generate video output superimposing the video output represented by the overlay region over the video output represented by the video frame buffer in response to receiving user input forwarded to the baseboard management controller.

7. A system according to claim 4, the baseboard management controller further configured to, while the overlay is invoked, modify operational parameters associated with the at least one information handling system in response to receiving user input forwarded to the baseboard management controller.

8. A system according to claim 4, the baseboard management controller further configured to, while the overlay is invoked, display operational parameters associated with the at least one information handling system.

9. A system according to claim 4, the baseboard management controller further configured to, while the overlay is invoked, display operational parameters associated with the chassis.

10. A system according to claim 9, further comprising a chassis management controller configured to communicate to the baseboard management controller the operational parameters associated with the chassis.

11. A system according to claim 4, further comprising a chassis management controller, and the baseboard management controller further configured to forward to the chassis management controller the user input forwarded to the baseboard management controller.

12. A system according to claim 11, the user input forwarded to the baseboard management controller for modifying operational parameters associated with the chassis and the chassis management controller further configured to modify operational parameters in response to receiving the user input.

13. A modular information handling system comprising:
a processor;
a memory, the memory configured to store:
a video frame buffer representing video output to be displayed to a display communicatively coupled to the information handling system; and
an overlay region representing video output to be superimposed over the video output displayed to the display and represented by the video frame buffer when an overlay is invoked;
an overlay agent embodied in a computer-readable medium and comprising one or more executable instructions when read and executed by the processor for causing the processor to:
monitor for user input indicative of a user desire to invoke the overlay; and
communicate an indication that the user input indicative of the user desire to invoke the overlay has been received in response to receiving such user input;
a baseboard management controller communicatively coupled to the processor and the memory, the baseboard management controller configured to:
read the video frame buffer;
read the overlay region; and
generate video output superimposing the video output represented by the overlay region over the video output represented by the video frame buffer in response to receiving from the processor the indication.

14. An information handling system according to claim 13, the user input indicative of the user desire to invoke the overlay received from a keyboard-video-mouse interface communicatively coupled to the information handling system.

15. An information handling system according to claim 13, the baseboard management controller further configured to communicate to the keyboard-video-mouse interface video output superimposing the video output represented by the overlay region over the video output represented by the video frame buffer.

16. An information handling system according to claim 13, the overlay agent further configured to, while the overlay is invoked, forward user input to the baseboard management controller.

17. An information handling system according to claim 16, the overlay agent further configured to, while the overlay is invoked, prevent an operating system executing the on processor from receiving user input forwarded to the baseboard management controller.

18. An information handling system according to claim 16, the baseboard management controller further configured to, while the overlay in invoked:
modify content in the overlay region in response to user input forwarded to the baseboard management controller; and
generate video output superimposing the video output represented by the overlay region over the video output represented by the video frame buffer in response to receiving user input forwarded to the baseboard management controller.

19. An information handling system according to claim 16, the baseboard management controller further configured to, while the overlay is invoked, modify operational parameters associated with the at least one information handling system in response to receiving user input forwarded to the baseboard management controller.

20. An information handling system according to claim 16, the baseboard management controller further configured to, while the overlay is invoked, display operational parameters associated with the information handling system.

21. An information handling system according to claim 16, the baseboard management controller further configured to:
receive display operational parameters associated with a chassis housing the information handling system from a chassis;
while the overlay is invoked, display operational parameters associated with the chassis; and
while the overlay is invoked, forward to the chassis management controller the user input forwarded to the baseboard management controller, the user input forwarded to the baseboard management controller for modifying operational parameters associated with the chassis.
